(19) United States
(12) Patent Application Publication
(10) Pub. No.: US 2005/0079288 A1
(43) Pub. Date: Apr. 14, 2005

(54) Suppressing mono-valent metal ion migration using alumina-containing barrier layer

(76) Inventors: Lauren K. Cornelius, Painted Post, NY (US); Adam J. Ellison, Painted Post, NY (US); Sumalee Likitvanichkul, Corning, NY (US)

Correspondence Address: CORNING INCORPORATED, SP-TI-3-1, CORNING, NY, 14831, US

(21) Appl. No.: 10/936,061

(22) Filed: Sep. 7, 2004

Related U.S. Application Data
(60) Provisional application No. 60/500,635, filed on Sep. 5, 2003.

(51) Int. Cl. B05D 1/12

(52) U.S. Cl. 427/180; 427/372.2; 106/286.2; 106/286.5; 106/287.34

(57) ABSTRACT

Disclosed is a process for suppressing monovalent metal ion migration between inorganic materials by placing a barrier layer containing Al₂O₃ and SiO₂ between the inorganic materials. Also disclosed is a process for making silica-containing body comprising a step of forming a barrier layer containing Al₂O₃ and SiO₂ over the soot-receiving substrate before the laydown of the fused silica boule. The barrier layer is effective in suppressing monovalent metal ion migration, especially alkali metal ion, particular sodium ion, migration at elevated temperature. The processes are particularly useful in the production and working of high purity fused silica material required of a very low sodium concentration. The barrier layer material is prepared by using an aqueous suspension comprising silica soot.

### CROSS-REFEENCE TO RELATED APPLICATIONS

The present application claims priority of U.S. Provisional Patent Application Ser. No. 60/500,635, filed on Sep. 5, 2003, entitled “Alumina Barrier to Suppress Na Migration in HPFS,” the content of which is relied upon and incorporated herein by reference in its entirety.

### FIELD OF THE INVENTION

The present invention relates to materials and processes for suppressing monovalent metal ion migration between otherwise abutting inorganic materials. In particular, the present invention relates to aluminum-containing material and process for suppressing monovalent metal ion migration from one inorganic material having higher monovalent metal ion concentration to another inorganic material having lower monovalent metal ion concentration at elevated temperatures during the processing or production of the low-monovalent metal ion material. The present invention is useful, for example, in the production of low Na high purity fused silica material, doped or undoped.

### BACKGROUND OF THE INVENTION

Many inorganic materials, such as high purity fused silica (HPFS®), doped fused silica such as aluminum doped fused silica, fluorine doped fused silica, titanium doped fused silica, CaF₂, MgF₂, and the like, find use in many modern technologies, for example, in optical applications. In many of these applications, these materials are required to have extremely low level of metal contaminants. It is known that in the UV region, particularly in the deep UV and vacuum UV region significant for the microlithography technology, contamination by monovalent metal ions, especially alkali metal ions, particularly sodium ion, causes undesirable transmission loss and fluorescence in optical materials such as HPFS®. The exact cause is not well-understood, but appears to be due to the formation of non-bridging (for example, Si—O—Na) bonds in the glass. The fused silica glass material used in the microlithography market currently requires ArF laser (193 nm) internal transmission exceeding 99.65%/cm, and preferably exceeding 99.75%/cm. Reduction of metal contaminants, which have a major impact on UV transmission, plays a major role in the production of high transmission fused silica. The effects of metals, such as sodium, potassium and iron, are evident at the 10's of parts per billion level. Therefore, it is imperative to keep sodium and other monovalent metal ion contamination levels as low as possible during the processing and production of the materials to maintain high transmission of the glass material.

Titanium doped fused silica material, such as Corning glass code 7990, has found use in applications such as reflective mirror blanks due to its extremely low coefficient of thermal expansion. It is important to control the metal ion, especially monovalent metal ion, particularly sodium ion, contaminants level in this material as well because such contamination leads to CTE excursion and reduced CTE homogeneity.

In the technical field, an important process for making fused silica materials, doped or undoped, involves vapor phase hydrolysis and oxidation of precursor materials in a combustion flame. This process is typically called flame hydrolysis. Large high purity fused silica glass, doped or undoped, is typically made by depositing fine particles of silica in a refractory furnace at temperatures exceeding 1650° C. The silica particles are typically generated in a flame when a silicon containing raw material along with natural gas is passed through a fused silica producing burner into the furnace chamber. These particles are deposited and consolidated onto a rotating body. The rotating body is in the form of a refractory cup or containment vessel, which is used to provide insulation to the glass as it builds up, and the furnace cavity formed by the cup interior and the crown of the furnace is kept at high temperatures. The body formed by the deposited particles is often referred to as a “boule” and it is understood that this terminology includes any silica-containing body formed by a flame hydrolysis process.

A typical furnace for producing fused silica glass includes an outer ring wall, which supports a refractory crown. The crown is provided with a plurality of burner holes, and each such burner hole is provided with a burner positioned there above at an inlet end for directing a flame through the burner hole into the cavity of the furnace. The furnace is provided with a rotatable base, which with the containment wall forms a cup or containment vessel. The rotatable base, forming the bottom of the cup-like containment vessel, is covered with high purity bait sand which collects the initial silica particles forming the boule.

The refractory crown, having the burners positioned thereon, functions to trap heat within the furnace. However, since the flame and soot from the burners pass through the burner holes in the refractory crown, the burner holes are maintained at elevated temperature. Such elevated temperatures in the vicinity of each burner hole cause impurities to leach out of the refractory and produce undesirable dissolution of the refractory which contaminates the silica glass.

Various methods have been disclosed in the prior art in order to reduce the metal, especially sodium contamination of the fused silica material during the production in the furnace. Since the source of the metal contaminants are largely from the furnace walls, the cup and the bait sand, those methods are mostly focused on improvement on the furnace design and reduction of the level of metal contaminants in the furnace bricks and bait sands.

For example, U.S. Pat. No. 6,497,118 discloses a furnace in which the temperature of the refractory at the burner holes is reduced. The lowered burner hole refractory temperature reduces contaminants leached out from the refractory and leads to less undesirable dissociation of the refractory, thus reduces contamination of the fused silica material produced. U.S. Pat. Nos. 5,332,702 and 5,395,413 describe remedial measure taken to reduce the sodium content in the fused silica glass. Essentially, these measures comprise providing a purer zircon refractory for use in constructing a furnace in which the fused was deposited to form a boule. In particular, it was found necessary to use dispersants, binders and water relatively free of sodium ions in producing zircon refractory components for the furnace. U.S. Pat. No. 6,174,509 discloses a method of treating the refractory of the furnace with halogen-containing gas to reduce the contamination level.

However, further improvement to the production of fused silica and other inorganic materials is needed in order to reduce the level of metal contamination, especially sodium contamination of HPFS® at elevated temperatures.

In the processing and handling of inorganic materials at elevated temperature, such as sagging of fused silica material at a temperature over 1650° C., it is important that metal contaminants, especially monovalent metals, particularly sodium, do not migrated from the surface of the support material to the fused silica. Therefore, there exists the need of suppressing monovalent metal ion migration from the support to the fused silica material.

The present invention satisfies these needs.

### SUMMARY OF THE INVENTION

According to one aspect of the present invention, it is provided a process for suppressing monovalent metal ion migration from a first inorganic material to a second inorganic material at an elevated temperature, comprising forming a barrier layer sandwiched between the surfaces of the first inorganic material and the second inorganic material. The barrier layer comprises alumina and silica and is prepared from an aqueous slurry comprising silica soot.

Preferably, the aqueous slurry of silica soot is prepared from silica soot having an average particle size less than 500 μm, more preferably less than 100 μm, more preferably less than 50 μm, still more preferably less than 10 μm, most preferably less than 1 μm. Preferably, the silica soot is produced by flame hydrolysis and has a sodium concentration less than about 10 ppm, preferably less than 5 ppm, more preferably less than 1 ppm. The barrier layer, when completely dried, preferably consists essentially of Al₂O₃ and SiO₂. The amount of Al₂O₃ in the dried barrier layer may be in the range from 1% to 99% by weight of the total of Al₂O₃ and SiO₂, preferably from 3% to 90%, more preferably from 10% to 80%, still more preferably from 20% to 60%.

In one embodiment of the process for suppressing monovalent metal ion migration of the present invention, the barrier layer is formed in accordance with a process comprising the following steps:
(i) providing an alkaline aqueous suspension of silica soot;
(ii) providing a hydrolysable aluminum compound having the general formula
   Sₒ—Al—Yₚ (I)
   and/or hydrates thereof,
   where S independently is a non-hydrolysable group, Y independently is a hydrolysable group, o is an integer from 0 to 2, inclusive, p is an integer from 1 to 3, inclusive, and o+p=3; and
(iii) adding the hydrolysable aluminum compound (I) or hydrates thereof provided in step (ii), and/or a solution/suspension thereof, while stirring, to the silica soot suspension provided in step (i), to form an aqueous slurry.

In this embodiment, preferably, in formula (I), S independently is selected from optionally fluorinated C₁-C₂₄ alkyl and optionally fluorinated phenyl, and Y independently is selected from the group consisting of Cl, Br, I, NO₃, NO₂, CH₃COO, hydrogen and OR′ where R′ is a C₁-C₄ alkyl. More preferably, the hydrolysable aluminum compound is AlCl₃ and/or hydrates thereof.

In another embodiment of the process for suppressing monovalent metal ion migration of the present invention, the barrier layer is formed in accordance with a process comprising the following steps:
(A) providing an alkaline aqueous suspension of silica soot;
(B) providing a suspension of alkaline aqueous suspension of alumina particles;
(C) mixing the suspension of silica soot provided in step (A) with the suspension of alumina particles provided in step (B) to form an aqueous slurry.

In this embodiment, preferably, in step (B), the alumina is α-alumina and/or γ-alumina, with the latter more preferred.

In yet another embodiment of the process of the present invention for suppressing monovalent metal ion migration, the barrier layer is formed in accordance with a process comprising the following steps:
(a) providing an alkaline aqueous suspension of silica soot; and
(b) adding, while stirring, alumina particles to the aqueous suspension of silica soot to form an aqueous slurry.

In this embodiment, preferably, in step (b), the alumina particles are α-Al₂O₃ and/or γ-Al₂O₃, with the latter more preferred.

In yet another embodiment of the process of the present invention for suppressing monovalent metal ion migration, the barrier layer is formed in accordance with a process comprising the following steps:
(1) providing an alkaline aqueous suspension of alumina particles; and
(2) adding, while stirring, silica soot into the aqueous suspension provided in step (1) to form an aqueous slurry.

In this embodiment, preferably, in step (1), the alumina particles are α-Al₂O₃ and/or γ-Al₂O₃, with the latter more preferred.

In still another embodiment of the process of the present invention for suppressing monovalent metal ion migration, the barrier layer is formed in accordance with a process comprising the following steps:
(x) providing an alkaline aqueous solution; and
(y) adding, while stirring, silica soot and alumina particles into the aqueous suspension provided in step (x) to form an aqueous slurry.

In this embodiment, preferably, in step (y), the alumina particles are α-Al₂O₃ and/or γ-Al₂O₃, with the latter more preferred.

In a preferred embodiment of the process of the present invention for suppressing monovalent metal ion migration, the barrier layer is formed by the following steps:
(A1) providing an aqueous slurry comprising silica soot and alumina particles;
(A2) drying the slurry provided in step (A1) to obtain a solid mixture of Al₂O₃ and SiO₂;
(A3) reducing the solid mixture obtained in step (A2) into particles; and
(A4) depositing a layer of particles obtained in step (A3) between the first and second inorganic materials as the barrier layer.

In another preferred embodiment of the process of the present invention for suppressing monovalent metal ion migration, the barrier layer is formed by the following steps:
(A1) providing an aqueous slurry comprising silica soot and alumina particles;
(A2′) depositing a layer of the slurry provided in step (A1) over the contacting surface of at least the first inorganic material;
(A3′) drying the slurry and heating the slurry to an elevated temperature to form the barrier layer between the first and second inorganic materials in situ.

A second aspect of the present invention is a process for forming silica-containing body, comprising the following steps:
(a1) providing a substrate having a top surface;
(a2) providing a barrier layer comprising alumina and silica that suppresses monovalent metal ion migration at elevated temperature over the top surface of the substrate, wherein the barrier layer is prepared from an aqueous suspension comprising silica soot;
(a3) providing soot particles at an elevated temperature; and
(a4) collecting the soot particles on top of the barrier layer to form the silica-containing body at an elevated temperature in a furnace.

The process for making fused silica body of the present invention can advantageously be used where the substrate provided in step (a1) has a high sodium concentration of at least 500 ppb, and where in step (a3) and/or (a4) the temperature is over 1500° C. However, to produce HPFS® materials, it is preferred that the substrate has a monovalent metal ion concentration of below 500 ppm, more preferably less than 100 ppm, still more preferably less than 50 ppm, most preferably less than 10 ppm.

In one embodiment of the process of the present invention for the production of silica-containing body, after step (a1) and before step (a2), an additional step (b1) as follows is provided:
(b1) providing a bait sand layer on the top surface of the substrate; whereby in step (a2), the barrier layer is formed on top of the bait sand layer provided in step (b1). The process of the present invention for the production of silica-containing body can advantageously be used where in step (b1)), the bait sand has a sodium concentration of at least 500 ppb. However, to produce HPFS® materials, it is preferred that the intermediate bait sand has a monovalent metal ion concentration of below 500 ppm, more preferably less than 100 ppm, still more preferably less than 50 ppm, most preferably less than 10 ppm.

In a preferred embodiment of the process of the present invention for the production of silica-containing body, in step (a2), the silica soot comprised in the aqueous suspension for the formation of the barrier layer has an average diameter of less than having an average particle size less than 500 μm, more preferably less than 100 μm, more preferably less than 50 μm, still more preferably less than 10 μm, most preferably less than 1 μm. Preferably, the silica soot is produced by flame hydrolysis and has a sodium concentration less than about 10 ppm, preferably less than 5 ppm, more preferably less than 1 ppm. The barrier layer, when completely dried, preferably consists essentially of Al₂O₃ and SiO₂. The amount of Al₂O₃ in the dried barrier layer may be in the range from 1% to 99% by weight of the total of Al₂O₃ and SiO₂, preferably from 3% to 90%, more preferably from 10% to 80%, still more preferably from 20% to 60%.

In one embodiment of the process for the production of silica-containing body of the present invention, the barrier layer is formed in accordance with a process comprising the following steps:
(i) providing an alkaline aqueous suspension of silica soot;
(ii) providing an aqueous solution/suspension of a hydrolysable aluminum compound having the general formula
   Sₒ—Al—Yₚ (I)
   and/or hydrates thereof,
   where S independently is a non-hydrolysable group, Y independently is a hydrolysable group, o is an integer from 0 to 2, inclusive, p is an integer from 1 to 3, inclusive, and o+p=3; and
(iii) mixing the silica soot suspension provided in step (i) with the aqueous solution/suspension provided in step (ii) while stirring to form an aqueous slurry.

In this embodiment, preferably, in formula (I), S independently is selected from optionally fluorinated C₁-C₂₄ alkyl and optionally fluorinated phenyl, and Y independently is selected from the group consisting of Cl, Br, I, NO₃, NO₂, CH₃COO, hydrogen and OR′ where R′ is a C₁-C₄ alkyl. More preferably, the hydrolysable aluminum compound is AlCl₃ and/or hydrates thereof.

In another embodiment of the process for the production of silica-containing body of the present invention, the barrier layer is formed in accordance with a process comprising the following steps:
(A) providing an alkaline aqueous suspension of silica soot;
(B) providing a suspension of alkaline aqueous suspension of alumina particles;
(C) mixing the suspension of silica soot provided in step (A) with the suspension of alumina particles provided in step (B) to form an aqueous slurry.

In this embodiment, preferably, in step (B), the alumina is a-alumina and/or γ-alumina.

In yet another embodiment of the process of the present invention for the production of silica-containing body, the barrier layer is formed in accordance with a process comprising the following steps:
(a) providing an alkaline aqueous suspension of silica soot; and
(b) adding, while stirring, alumina particles to the aqueous suspension of silica soot to form an aqueous slurry.

In this embodiment, preferably, in step (b), the alumina particles are α-Al₂O₃ and/or γ-Al₂O₃, with the latter more preferred.

In yet another embodiment of the process of the present invention for the production of silica-containing body, the barrier layer is formed in accordance with a process comprising the following steps:
(1) providing an alkaline aqueous suspension of alumina particles; and
(2) adding, while stirring, silica soot into the aqueous suspension provided in step (1) to form an aqueous slurry.

In this embodiment, preferably, in step (1), the alumina particles are α-Al₂O₃ and/or γ-Al₂O₃, with the latter more preferred.

In still another embodiment of the process of the present invention for the forming silica-containing bodies, the barrier layer is formed in accordance with a process comprising the following steps:
(x) providing an alkaline aqueous solution; and
(y) adding, while stirring, silica soot and alumina particles into the aqueous suspension provided in step (x) to form an aqueous slurry.

In this embodiment, preferably, in step (y), the alumina particles are α-Al₂O₃ and/or γ-Al₂O₃, with the latter more preferred.

In a preferred embodiment of the process of the present invention for the production of fused silica body, the barrier layer is formed by the following steps:
(A1) providing an aqueous slurry comprising silica soot and alumina particles;
(A2) drying the slurry provided in step (A1) to obtain a solid mixture of Al₂O₃ and SiO₂;
(A3) reducing the solid mixture obtained in step (A2) into particles; and
(A4) depositing a layer of particles obtained in step (A3) over the top surface of the substrate to form the barrier layer.

In another preferred embodiment of the process of the present invention for the production of silica-containing body, the barrier layer is formed by the following steps:
(A1) providing an aqueous slurry comprising silica soot and alumina particles;
(A2′) depositing a layer of the slurry provided in step (A1) over the top surface of the substrate; and
(A3′) drying the slurry and heating the slurry to an elevated temperature to form the barrier layer over the top surface of the substrate.

According to a preferred embodiment of the process of the present invention for the production of silica-containing body, the silicon-containing body formed has a Na concentration less than 20 ppb in the area abutting the barrier layer, preferably less than 10 ppb, more preferably less than 5 ppb, most preferably less than 1 ppb.

In a preferred embodiment of the process for the production of silica-containing body of the present invention, the barrier layer, when dried and subjected to a temperature over 1200° C., has a thickness less than 2 cm.

In a preferred embodiment of the process for the production of silica-containing body of the present invention, the silicon-containing body is formed in a direct-deposit flame hydrolysis furnace, and the substrate provided in step (a1) is the bottom of the rotating cup for collecting the soot and forming the body therein.

The required thickness of the barrier layer depends on monovalent metal ion concentration ingredient between the substrate/bait sand and the silica-containing body to be formed as well as Al₂O₃ concentration in the barrier layer. For a substrate or bait sand used having a sodium concentration of about 3 ppm, a Al₂O₃—SiO₂ barrier layer comprising about 8 wt % Al₂O₃ about 2 cm thick is sufficient to suppress monovalent metal ion, particularly Na, migration for the production of a high purity fused silica boule in a typical direct-deposit furnace, such that the monovalent metal ion concentration at the bottom area close to the substrate produced is substantially reduced.

A third aspect of the present invention is a barrier material comprising alumina and silica for suppressing the migration of monovalent metal ion between inorganic materials at an elevated temperature, wherein the amount of alumina in the barrier material is between 3% and 90% by weight of the total amount of alumina and silica, and the barrier material has a sodium diffusion coefficient at 1000° C. of less than 1×10⁻⁸ cm²/s. Preferably, in the barrier material, the amount of alumina is between 5% and 80%, more preferably between 10% and 80%, still more preferably between 10% and 60%, still more preferably between 20% and 60%, of the total amount of alumina and silica. Preferably, the barrier material consists essentially of alumina and silica when dried. Preferably, the barrier material has a sodium diffusion coefficient at 1000° C. of less than 1×10⁻¹⁰ cm²/s. Preferably, the barrier material has a monovalent metal ion concentration less than 50 ppm, preferably less than 30 ppm, more preferably less than 20 ppm, most preferably less than 10 ppm. Preferably, the barrier material has a sodium ion concentration less than 50 ppm, preferably less than 20 ppm, more preferably less than 5 ppm, most preferably less than 500 ppb. Preferably, for the best effect in suppressing the migration of monovalent metal ions, it is preferred that the silica and alumina distribute substantially evenly in the material. Preferably, the barrier material forms a continuous layer when subjected to the elevated temperature at which the material is used. For the production of HPFS® material, it is preferred that the barrier material forms a continuous layer at a temperature about 1500° C.

The present invention has the advantages of suppressing monovalent metal ion, especially alkali metal ion, particularly sodium ion, migration between inorganic materials at a relatively low cost. The barrier layer is easy to form and it suppresses sodium migration effectively. High concentration of Al₂O₃ can be achieved in the barrier layer material according to the processes of the present invention by using a silica soot aqueous slurry. The barrier layer is easy to integrate into current HPFS® production furnaces to produce fused silica boules with significantly lower sodium concentration in the bottom area.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings:

FIG. 1 is a schematic illustration of the direct-deposit furnace for the production of fused silica boule;

FIG. 2 is a diagram of the electron microprobe analysis result of the Na and Al concentration of the Al-rich glass-fused silica sandwich of Example 1, moving from the Al-rich glass to the fused silica;

FIG. 3 is a diagram showing the Na concentration profile in the fused silica disk sample of Example 1, and an erfc fit curve thereof;

FIG. 4 is a diagram showing the curve of calculated diffusion coefficient of fused silica as a function of temperature at elevated temperatures;

FIG. 5 is a schematic illustration of how the sample center section of Example 2 is taken from the center of the boule produced in the single burner refractory furnace;

FIG. 6 is a schematic illustration of how the center section taken from the center of the boule produced in Example 2 is further sliced into test sample subsections;

FIG. 7 is diagram showing the concentration of sodium as a function of distance from the top of the boule produced in Experiments A, B, C and D of Example 2;

FIG. 8 is a partial enlargement of the diagram of FIG. 7 to show more details;

FIG. 9 is a diagram showing the correlation between the aluminum concentration in the barrier layer/bait material and sodium concentration at various distances from the top of the boules in the fused silica boules produced in Example 2.

FIG. 10 is a diagram showing the concentration of sodium as a function of distance from the bottom of the boules produced in Experiments E, F and G of Example 5.

### DETAILED DESCRIPTION OF THE INVENTION

As used herein, the term “fused silica” includes undoped high purity fused silica and fused silica materials with various amounts of dopants, such as fluorine, aluminum, titanium, and the like, unless otherwise specified. The term “elevated temperature” means a temperature higher than 500° C., preferably higher than 800° C., more preferably higher than 1000° C., still more preferably higher than 1500° C. “Silica soot” means particulate silica materials having an average particle size less than 1 mm, preferably less than 500 μm, more preferably less than 100 μm, still more preferably less than 50 μm, still more preferably less than 10 μm, most preferably less than 1 μm. A “solution/suspension” is a mixture that is a solution which contains solubilized substances, a suspension contains particles of unsolubilized substances, or a mixture of both. The term “monovalent metal ion” means ion and ions selected from the group consisting of alkali metal ions, Ag⁺ and Cu⁺.

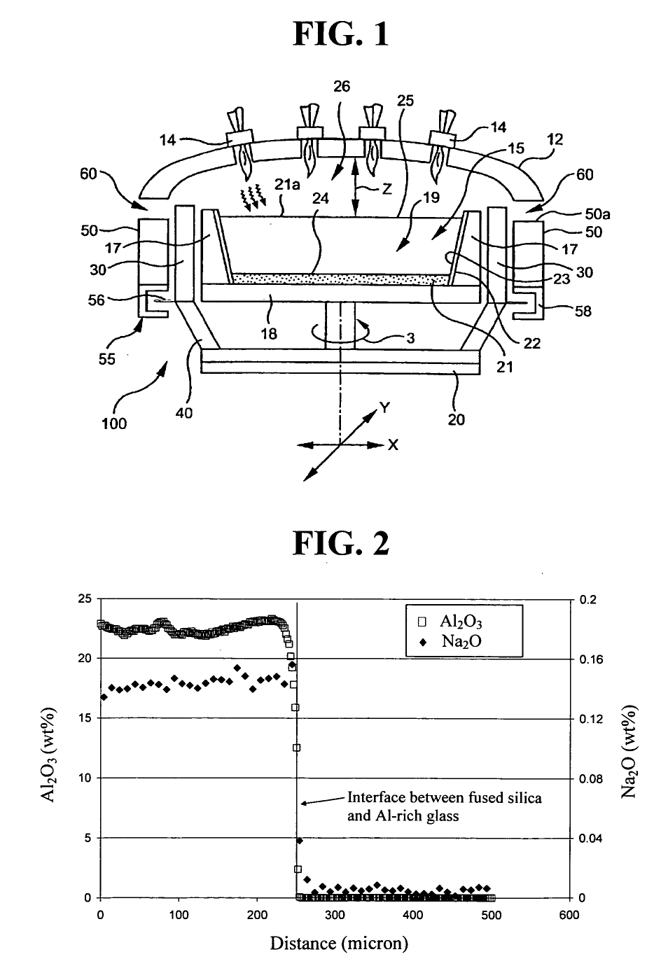

FIG. 1 shows a typical direct-deposit furnace 100 for producing fused silica glass. The furnace includes a crown 12 and a plurality of burners 14 projecting from the crown. Silica particles are generated in a flame when a silicon-containing raw material together with a natural gas is passed through the plurality of burners 14 into the furnace chamber 26. These particles are deposited on a hot collection surface of a rotating body where they consolidate to the solid, glass state. The rotating body is in the form of a refractory cup or containment vessel 15 having lateral walls 17 and a collection surface 21 which surround the boule 19 and provide insulation to the glass as it builds up. The refractory insulation ensures that the cup interior and the crown are kept at high temperatures.

The furnace further includes a ring wall 50 which supports the crown 12. The furnace further includes a rotatable base 18 mounted on an oscillation table 20. The base is rotatable about an axis 3. The crown 12, the ring wall 50, the base 18 and the lateral walls 17 are all made from suitable refractory materials.

The cup or containment vessel 15 is formed on the base 18 by means of lateral cup walls or containment walls 17 mounted on the base 18, which forms the cup or containment vessel 15. The lateral cup or containment walls 17 and the portion of the base 18 surrounded by the walls 17 is covered with high purity bait sand 24 which provides collection surface 21 for collecting the initial silica particles produced by the burners 14. Bait sand used may be, for example, ground zircon (ZrO₂.SiO₂) or zirconia (ZrO₂) particles. During deposition and consolidation of the silica particles into a solid glass, the boule 19 is formed having sidewalls 23 and an upper major surface 25. As the boule 19 is formed during the deposition process, the upper major surface 25 of the boule 19 becomes the collection surface 21a for the silica particles. The burners 24 and the collection surface 21a have a distance z. The lateral walls 17 can be made from refractory blocks such as alumina base block for forming the walls 17 and an inner liner made of a suitable refractory material such as zircon or zirconia.

Surrounding the lateral walls 17 of the cup or containment vessel 15 is a shadow wall or air inflow wall 30. The shadow wall 30 is mounted on x-y oscillation table 20 by feet 40, for example four feet equally spaced around the circumference of the shadow or air inflow wall 30. Details on the construction a shadow wall and a furnace using a shadow wall may be found in U.S. Pat. No. 5,951,730, the entire contents of which are incorporated herein by reference. Other ways of mounting the air inflow wall to the oscillation table can be used if desired. The stationary ring wall 50 surrounds the ring wall and supports the crown 12. A seal 55 is provided between the stationary ring wall 50 and the air flow wall or shadow wall 30. The seal 55 includes an annular plate 56, which rides in or slides in an annular channel 58 formed within the stationary ring wall 50. The annular channel 58 can include a C-shaped annular metal plate which forms the bottom of the stationary wall. Other forms of motion-accommodating seals can be used if desired, including flexible seals composed of flexible metal or refractory cloth, which, for example, can be in the form of bellows.

The products of combustion in the furnace 100 are exhausted through ports 60 circumferentially spaced around the furnace. In a typical furnace, six ports 60 are provided, and the ports 60 are located between crown 12 and the top edge 50a of the stationary wall, such that the ports 60 are located above the deposition surface 21 and 21a during formation of the boule.

Boules typically having diameters on the order of five feet (1.5 meters) and thicknesses on the order of 5-10 inches (13-25 cm) can be routinely produced in large production furnaces of the type shown in FIG. 1. Multiple blanks are cut from such boules and used to make the various optical members referred to above. The blanks are generally cut in a direction parallel to the axis of rotation of the boule in the production furnace, and the optical axis of a lens element made from such a blank will also generally be parallel to the boule's axis of rotation in the furnace. For ease of reference, this direction will be referred to as the “axis 1” or “use axis”.

As discussed supra, sodium containment in the boules should be avoided at all costs. The transmission penalty at 193 nm for sodium in fused silica material, such as Coming 7980 and 7990 glasses, is about 0.006%/cm/ppb. Other monovalent metal ions, especially alkali metal ions, such as potassium ion, are detrimental to the transmission properties of the high purity fused silica materials as well. Less monovalent metal ions, particularly sodium, in the boules would have several major impacts, inter alia: (i) transmission at deep and vacuum UV will be improved; (ii) fluorescence of the glass will be reduced; and (iii) more useable glass could be extracted form the boule, from both its radius and depth. Unfortunately, sodium is an ubiquitous contaminant in most materials, particularly natural-derived materials such as the bait sand and refractories used to manufacture HPFS®. The exact origins of the sodium are unknown. As discussed above, it has been surmised that the sodium may have been mobilized from the refractory bricks in building the furnace, and accordingly methods such as reducing brick temperature at the burner holes and reducing sodium content in the refractories have been proposed to reduce sodium level in the boule.

It is known that sodium diffusion in pure silica is extraordinarily rapid, on the order of 10⁻⁶ cm²/sec at a temperature as low as 1000° C. For example, in the Kirk-Othermer Encyclopedia of Chemical Technology. 4th Edition, volume 21, page 1047, it is disclosed that the diffusion coefficient of sodium ion in vitreous silica at 1000° C. is 7.9×10⁻⁶cm²/s. The research of Dieckmann et al. using ²²Na tracer diffusion gave similar result. See Lei Tian, Rudiger Dieckmann et al, Effect of water incorporation on the diffusion of sodium in Type I silica glass, Journal of Non-Crystalline Solids (2001), page 146-161. The mean diffusion path length is therefore ˜\sqrt{2Dt}, which translates to approximately 1 mm per hour at 1000° C.

Dieckmann has found that the presence of aluminum oxide drastically decreases the diffusion coefficient for sodium in silica, such that at 25 mol % Al₂O₃ the diffusivity is down 6 orders of magnitude relative to silica at the same temperature.

The present inventors have found compelling evidences indicating that the primary source of sodium in the boules produced in a furnace of the type of FIG. 1 is the brick in the cup and the bait sand of the laydown furnace. While chlorine treatment reduces the total amount of sodium available, approximately 3 ppm sodium is routinely retained in the bricks and bait sand. This sodium is not susceptible to removal by either chlorine treatment or aggressive acid leaching. However, the present inventors believe that, the sodium is readily mobilized simply by heating the brick up to temperatures in excess of 1000° C. While not intending to be bound by any particular theory, it is believed that the sodium originates largely from the use of sodium metasilicate hydrate (“water glass”) as a binder in brick fabrication and from the bait sand, especially during the early stages of laydown. The fact that sodium diffuses very rapidly in vitreous fused silica at elevated temperature explains why sodium is present in so many places in the final silica boule. Indeed, it is now found that sodium concentration gradient exists in the boules produced which decreases from the bottom (closer to the bait sand) to the top (closer to the burners). This strongly suggests that the primary sodium source is the bait sand and the refractory cup below.

Based on the above understandings, the instant inventors made the present invention with the aim to suppress sodium migration from one material, for example, the bait sand or the refractory of the cup, to another, for example, the fused silica boule formed over the bait sand. The present invention achieves this goal by using an aluminum-containing barrier layer between the sodium source material and the potential sodium recipient material. Because the diffusion behavior of monovalent ions in inorganic materials at elevated temperatures share a lot of similarities, it is believed that the present invention is applicable for other monovalent metal ions, including other alkali metal ions, Ag⁺ and Cu⁺. The present invention will be described particularly in connection with sodium ion because it is an important ion in the production and working of high purity fused silica materials. However, it is to be noted that the present invention is not merely applicable for suppressing sodium migration.

The processes of the present invention will be described in more detail as follows.

A first aspect of the present invention is directed to a general process for suppressing sodium migration from a first inorganic material to a second inorganic material at an elevated temperature. Diffusion of sodium ions in and between solid materials have been researched and studied in the art. The diffusion examined includes, for example, surface diffusion, grain boundary diffusion (diffusion along the grain boundary of crystalline or non-crystalline materials), and volume diffusion (diffusion within the body of a bulk crystalline or non-crystalline articles). Generally, surface diffusion and grain boundary diffusion are much faster than volume diffusion. Normally, when two solid inorganic materials having substantially different sodium concentrations are placed into contact with each other, thermodynamically sodium ions tend to diffuse from the higher concentration area to the lower concentration area. At low temperature, for example, room temperature, the diffusion may not be very noticeable. However, at an elevated temperature, for example, at the typical temperature at which fused silica glass is produced in a FIG. 1 furnace, about 1650° C., such diffusion becomes much faster. Therefore, sodium diffusion and contamination becomes a problem when materials are produced or worked at an elevated temperature on a substrate having higher sodium concentration. For the purpose of convenience and clarity in discussion, in the present application, it is stipulated that the prevailing diffusion direction of monovalent metal ions, particularly ions at elevated temperature is from the first inorganic material to the second inorganic material when they are placed into direct contact with each other until an equilibrium is reached.

As discussed supra, the presence of Al₂O₃ in silica drastically reduces the diffusivity of sodium in silica, such that at 25% by mole Al₂O₃ the diffusivity is down 6 orders of magnitude relative to silica at the same temperature. The process of the present invention for suppressing sodium (and other monovalent metal ions) migration from one inorganic material to another takes advantage of this interesting property. This process may be advantageously employed in the production and processing of any high purity inorganic materials for which sodium contamination poses a problem. Whereas the present invention is primarily described in the context of the production of high purity fused silica (HPFS®) material in a high temperature furnace using flame hydrolysis process, it is to be understood that the process may also be used in many other processes in which high purity materials are susceptible to exposure to high monovalent metal ion concentration environment. For example, the present invention process may be used for the production and processing (annealing, for example) of other high purity materials, such as CaF₂ and MgF₂ crystals. For another example, the present invention may be used in processes in which high purity fused silica is worked, such as molding and sagging of HPFS® to produce optical members, and consolidation of porous fused silica bodies.

The barrier layer may contain Al₂O₃ in the amount, by weight, from 3-90% of the total of silica and alumina when dried. The barrier layer may contain, in addition to Al₂O₃ and SiO₂, other metals, especially multiple valent metals, having a low difflusivity at elevated temperature, for example, Ca, Mg, La, and the like. Preferably, the barrier layer material used in the processes of the present invention, when completely dried, consists essentially of Al₂O₃ and SiO₂, meaning that, the total of Al₂O₃ and SiO₂ is at least 99% weight of the barrier layer. The barrier layer may contain a higher amount of monovalent metal ion than in the second inorganic material. However, for a second inorganic material desired to have a sodium concentration lower than 100 ppb, it is desired that the barrier layer has a sodium concentration lower than 1000 ppb, preferably lower than 500 ppb. It is desired that the barrier layer, when heated to the elevated operation temperature, forms an essentially continuous layer, whereby grain boundary diffusion is minimized. The thickness of the barrier layer depends on, inter ia the monovalent metal ion concentration gradient between the first and second inorganic materials, the temperature profile to which the materials are exposed, and the requirement as to the sodium level in the second inorganic material. Generally, a higher Al₂O₃ content in the barrier material is desired, for volume diffusion in barrier materials having higher Al₂O₃ tends to be lower.

Preferably, the barrier layer material has a sodium volume diffusion coefficient at 1000° C. of less than 1×10⁻⁸ cm²/s, more preferably less than 1×10⁻¹⁰ cm²/s when it is used in connection with the production and/or working of high purity fused silica materials.

A salient feature of the process of the present invention for suppressing monovalent metal ion migration between inorganic materials and the process for forming silica-containing bodies is the use of silica soot aqueous slurry or suspension in the formation of the barrier layer.

U.S. patent application Publication No. 2003/0121283 A1 (“Yu”) discloses a process for making a high solid-loading silica soot suspension or slurry, the content of which is relied upon and incorporated herein by reference in its entirety. The process disclosed in this reference involves the use of aqueous ammonia solution as the dispersing medium. It is reported in this reference that the solid loading of silica soot the aqueous slurry can be as high as 75% by weight. The slurry can be molded into a desired shape, then dried under reduced pressure to form a dense green body, which can be further dried and calcined to form consolidated fused silica body.

However, whether this process could be used to produce Al₂O₃—SiO₂ materials, especially those having a high Al₂O₃ percentage, is not disclosed or suggested in Yu. Yu discloses that the successful formation of a stable fused silica suspension is the maintenance of an alkaline pH. It is unclear, from Yu, whether the formation of a stable slurry containing SiO₂ particles, Al₂O₃ or other aluminum compounds can be achieved under similar conditions. Moreover, it is highly desired that the Al₂O₃ particles are substantially evenly distributed in the Al₂O₃—SiO₂ material to be produced. Yu certainly has no teaching or suggestion in this respect.

The present inventors have found that a solid mixture comprising Al₂O₃—SiO₂ can be produced using an alkaline aqueous soot suspension of silica soot, hydrolysable aluminum compounds, and/or alumina particles. The present inventions have found that, the Al₂O₃—SiO₂ solid mixture can be produced from an aqueous slurry comprising silica soot by using various methods. Surprisingly, the present inventors have found that a solid mixture comprising Al₂O₃—SiO₂ can be produced with a very high Al₂O₃ content (for example, 90% by weight of the total of Al₂O₃ and SiO₂). From the above discussion, it is believed that a higher Al₂O₃ content in the barrier layer is generally conducive to the monovalent-metal-ion-suppression function. Therefore, it is desired that the Al₂O₃—SiO₂ solid mixture for use as the barrier layer comprises Al₂O₃ in the amount of 3-90% by weight, preferably 5-80%, more preferably 10-80%, still more preferably between 20-60%, of the total amount of alumina and silica.

The silica soot particles are preferred to have an average particles size of less than 500 μm, more preferably less than 100 μm, more preferably less than 50 μm, still more preferably less than 10 μm, most preferably less than 1 μm.

Silica soot from various sources may be used for the production of the barrier layer material for use in the processes of the present invention. However, preferably such silica soot is produced in a flame hydrolysis process, such as the typical process for making high purity fused silica. Silica soot produced in these processes tend to have a higher purity and a lower sodium content. Moreover, the silica soot thus produced usually has submicron sizes. For example, the silica soot particles generated in the HPFS® production furnaces used by Corning Incorporated has an average size of 0.2 μm. An advantage of using such silica soot produced in HPFS® production furnace is the economic benefit of converting an otherwise expensive waste into an extra value.

Other potentially useful silica particles suitable for the present invention include, for example, fumed silica produced by flame hydrolysis which consists of high purity, non-spherical silica particulate measuring less than 30 nm in size and having extremely high specific surface area. Even though fumed silica is used as catalyst support or as additives, it is rather difficult to form ceramic shape directly from the fumed silica. There are numerous other commercially available sources of fine size (sub-micron) silica particles, such as Cab-O-Sil® (by Cabot Corporation), Aerosil® (by Degussa), and Ludox® (by Du Pont), any of which may be used in the present invention, with or without further acid treatment to reduce the concentration of monovalent metal ions. Ludox® consists of aqueous media-dispersed spherical silica particles. The particle size of the silica in Ludox is in nanometer range, and the solid loading is normally below 50 wt %. Ludox is also used mainly as additives, and is very difficult to form directly into ceramic shapes. In addition, Ludox normally contains 0.5-0.5 wt % Na₂O. Therefore, for many applications of the present application, especially in the production and processing of high purity fused silica and the like, it is desired to purify Ludox to reduce the content of monovalent metal ions before its use in the present invention.

For the barrier layer to be useful as an effective means for suppressing monovalent metal ion migration, the barrier layer material itself is required to have a relatively low monovalent metal ion, especially alkali metal ion, particularly sodium ion, content. For example, when used for the production and processing of high purity inorganic materials required to have a sodium content of less than 100 ppb, it is desired that the barrier layer contains sodium less than 50 ppm, preferably less than 20 ppm, more preferably less than 10 ppm, still more preferably less than 5 ppm, still more preferably less than 1 ppm, most preferably less than 500 ppb. Therefore, it is preferred that the silica soot used for the production of the barrier layer has such a low sodium level. In case the silica soot has a much higher sodium level, acid treatment thereof may be carried out to reduce the sodium level before it is used to produce the barrier layer material.

One method of producing the barrier layer to be used in the processes of the present invention involves adding at least one hydrolysable aluminum compound or a solution/suspension thereof into a pre-formed alkaline suspension of the silica soot. The silica soot suspension may be a suspension stabilized by ammonia as disclosed in Yu. High purity water and ammonia aqueous solution should be used in order to reduce the sodium and other metal level in the barrier layer material to be produced. It is desired that the silica soot is allowed to age in the alkaline aqueous suspension and to reach an equilibrium before the introduction of the aluminum compound. The hydrolysable aluminum compound may be represented by the following general formula:
Sₒ—Al—Yₚ (I)
and/or hydrates and mixtures thereof,
where S independently is a non-hydrolysable group, Y independently is a hydrolysable group, o is an integer from 0 to 2, inclusive, p is an integer from 1 to 3, inclusive, and o+p=3.

In this embodiment, preferably, in formula (I), S independently is selected from optionally fluorinated C₁-C₂₄ alkyl and optionally fluorinated phenyl, and Y independently is selected from the group consisting of Cl, Br, I, NO₃, NO₂, CH₃COO, hydrogen and OR′ where R′ is a C₁-C₄ alkyl. More preferably, the hydrolysable aluminum compound is selected from the group consisting of AlCl₃, hydrates thereof, Al(NO₃)₃ and hydrated thereof, and their mixtures. The compound (I) may be (i-Pr-O)₃Al, (sec-C₄H₉-O)₃Al, and the like. Or combinations of AlCl₃, (i-Pr-O)₃Al, (sec-C₄H₉-O)₃Al and other organoaluminum compounds may be used.

It is preferred that the hydrolysable aluminum compound is first dissolved in high purity water before mixing it with the pre-formed silica soot suspension. Thus the aluminum compound has already undergone at least partial hydrolysis before mixing with the silica soot suspension. It is known that the aqueous solution of AlCl₃ or its hydrates is acidic. Therefore, it is preferred that the solution is slowly added into the silica soot suspension when mixing. If silica soot suspension is added slowly to the solution of AlCl₃, it can be expected that the silica soot particles would be soon exposed to an acidic environment and thus would conglomerate and precipitate. To achieve a high Al₂O₃ content in the barrier layer material, it is preferred that near saturate AlCl₃ solution is used. As the AlCl₃ solution is slowly added to the silica soot suspension, the pH of the suspension is lowered gradually, and the viscosity of the suspension increases accordingly, until the suspension is gelled. Stirring the mixture is required during the process of mixing in order to achieve an even distribution of both Al₂O₃ and Sio₂ in the barrier layer material to be produced.

The thus prepared gel can be applied directly on the contacting surface of the first inorganic material or the second inorganic material, or both, to form the barrier layer. Afterwards, the gel layer is dried, heated to a higher temperature to drive off the NH₄Cl and the like, optionally oxidized in an oxygen-containing environment (such as air, O₂—He mixture, and the like) and brought to an elevated temperature where it preferably forms a continuous layer. Alternatively, the gel may be dried, heated to a higher temperature to drive off the NH4Cl and the like, reduced to particles, and then applied on at least one contacting surface of the first and second inorganic materials. This method of adding aluminum-containing aqueous solution/suspension to silica soot suspension is difficult to obtain an Al₂O₃ content of higher than 20% by weight in the barrier layer material, because the AlCl₃ solution tends to cause the suspension to gel early.

A second method of forming the barrier layer material involves the formation and mixing of two alkaline aqueous suspension: an alkaline aqueous suspension of silica soot and an alkaline aqueous suspension of alumina. Because both suspensions are alkaline, the mixing of both does not cause the mixture to gel early. A third method involves the formation of an alkaline aqueous suspension of silica soot followed by addition of alumina particles thereto while stirring to obtain a alkaline aqueous suspension comprising both silica and alumina. A fourth method involves the formation of an alkaline aqueous suspension of alumina particles followed by addition of silica soot particles thereto while stirring to obtain a alkaline aqueous suspension comprising both silica and alumina. A fifth method involves the formation of an alkaline aqueous suspension of silica soot and alumina particles by adding them into an alkaline solution while stirring. In these four methods, the thus obtained alkaline suspensions are allowed to dry by evaporation of water therefrom, and/or allowed to gel by adjusting the pH by adding HCl, or other acids that are subjected to decomposition at elevated temperatures. The resulting mixture can be applied directly on at least one contacting surfaces of the first and second inorganic material, followed by heating and calcining as above, to form the barrier layer in situ. Or alternatively, the resulting mixtures can be dried, heated, calcined, reduced to particles, then applied as the barrier layer material as described above. In any of these four methods, the alumina particles used can be either α-Al₂O₃ and/or γ-Al₂O₃ particles, with the latter preferred, or mixtures thereof. In all these four methods, preferably ammonia aqueous solution is used as the pH adjustifier and suspension stabilizer.

Alumina is present and commercially available in various forms. α-alumina (α-Al₂O₃) is the aluminum oxide that is not hydroxylated. The chemical composition of α-Al₂O₃ is Al₂O₃. α-Al₂O₃ is available naturally and by high temperature calcination of Al(OH)₃ and the like. γ-alumina (γ-Al₂O₃), also called activated alumina, comprises a series of non-equilibrium forms of partially hydroxylated aluminum oxides. The chemical composition can be represented by Al₂O₍₃₋ₓ₎(OH)₂ₓ where 0<x 21 3. They are porous solids made usually by thermal treatment of Al(OH)₃ precursors and find application mainly as adsorbents, catalysts, and catalyst supports. Boehmetic alumina and/or calcined kaolin clay may be used as alternative alumina source.

The alumina particles for use in the processes of the present invention are required to have a high purity and low monovalent metal ion, particularly sodium ion, content. Generally, it is preferred that the Al₂O₃ particles have a monovalent metal ion, particularly sodium, content of less than 100 ppm, more preferably less than 50 ppm, still more preferably less than 10 p ppm, still more preferably less than 5 ppm, most preferably less than 1 ppm. To enable the formation of a stable suspension with low viscosity, the particles are preferred to have a small particle diameter of less than 500 μm, more preferably less than 200 μm, still more preferably less than 100 μm, most preferably less than 10 μm.

γ-Al₂O₃ is preferred over α-Al₂O₃ because it reacts more readily with an alkaline aqueous solution to form stable suspensions. Moreover, lab results suggested that γ-Al₂O₃ equilibrates to a lower pH than α-Al₂O₃, approximately 7.5 for γ-Al₂O₃ versus 9.8 for α-Al₂O₃. This suggests that at the same alkaline pH, for the same particle size, a γ-Al₂O₃ particle tends to have more surface charges than an α-Al₂O₃ particle. Moreover, it is believed that a higher amount of solubilized aluminum can be obtained by using γ-Al₂O₃. High solubilized aluminum concentration in the suspension is desirable because they will react with the silica soot to form a phase comparatively rich in aluminum. Such Al-rich phases are believed to be particularly effective for suppressing monovalent metal ion, especially Na, migration.

A great advantage of using alumina particles together with silica soot particles to form an alkaline suspension to prepare the barrier layer material is the ability to obtain barrier layer material with high Al₂O₃ content, for example, at least 20% by weight, even at least 50% by weight, and even higher, when dried. Such high Al₂O₃ content in the barrier layer is believed to be conducive to the monovalent metal ion, migration suppression capability.

Experiments showed that when γ-Al₂O₃ and fused silica soot were used as the starting materials to produce the barrier layer material as described above, and that the thus obtained material was used as the barrier layer for the production of fused silica material in a single-burner experimental direct-deposit furnace of the type shown in FIG. 1, the final HPFS® boule had a lower sodium level than those produced using zircon bait sand having a sodium content of approximately 3 ppm. Moreover, it has been found that the HPFS® boule produced released cleanly from the furnace floor, suggesting that the thus obtained Al₂O₃—SiO₂ can be used directly as the bait material in place of crushed zircon refractory which hitherto is typically used as the bait material. X-ray analysis of the material recovered from the experiment show that it was mostly crystalline and mostly mullite. This phase melts at approximately 1850° C., which explains why the bait released cleanly from the refractory. By contrast, addition of alumina to silica in small concentrations greatly steepens the viscosity curve of the glass, so all experiments performed with Al-doped waveguide silica glass produced using OVD (“OWG Bait” in Example 2, infra)) or Al-doped soot baits containing no more than 4 wt % Al₂O₃ (Example 3, infra) melted and flowed considerably during the laydown, flowing up the sides of the cup and binding strongly to the furnace floor. As a result, the boules often shattered on cooling and pulled up pieces of furnace refractory when they were removed. Therefore, the preferred method of producing the barrier layer material is the aqueous slurry approach using fused silica soot and alumina soot.

Another aspect of the present invention is an improved process for making fused silica body comprising the following steps:
(a1) providing a substrate having a top surface;
(a2) providing a barrier layer comprising alumina and silica that suppresses monovalent metal ion migration at elevated temperature over the top surface of the substrate, wherein the barrier layer is prepared from an aqueous suspension comprising silica soot;
(a3) providing soot particles at an elevated temperature; and
(a4) collecting the soot particles on top of the barrier layer to form the silica-containing body at an elevated temperature in a furnace.

The substrate provided in step (a1) can be the cup bottom 18 of the refractory cup in the furnace of FIG. 1, the mandrel in an OVD (outside vapor deposition) process, and the like. The substrate may have a monovalent metal ion concentration of up to 800 ppm, and a sodium concentration up to 500 ppm. As is mentioned supra, sodium concentration in the zircon cup refractory used in the FIG. 1 fused silica furnace typically contains about 3 ppm sodium. However, in order to produce HPFS® material, especially those qualified for 193-nm lithographic applications, it is desired that the substrate has a relatively low monovalent metal ion concentration of below 100 ppm, preferably below 50 ppm, and a sodium concentration of below 80 ppm, preferably below 30 ppm.

The barrier layer in step (a2) is provided substantially in the ways as described supra in connection with the process for suppressing monovalent metal ion migration of the present invention. The barrier layer material according to the present invention is prepared from an aqueous slurry containing silica soot particles. The aqueous slurry can be produced using the various methods described supra: (i) adding a hydrolysable aluminum compound, and/or a solution/suspension thereof into an alkaline aqueous suspension of silica soot; (ii) mixing alkaline aqueous suspension of silica soot and alkaline aqueous suspension of alumina; (iii) adding alumina particles into an alkaline aqueous suspension of silica soot; (iv) adding silica soot into an alkaline aqueous suspension of alumina; and (v) adding silica soot and alumina particles into an alkaline aqueous solution. The barrier layer may be the sole bait material used in the process for making fused silica body, or may be applied on top of an existing bait sand layer made of, for example, typical zircon materials or refractory alumina. The barrier layer may be deposited in ways described supra in connection with the process for suppressing monovalent metal ion migration of the present invention. Referring to FIG. 1, the barrier layer may be deposited on top of the bait sand layer 21 before the laydown of the fused silica boule 19. The bait sand material may have a monovalent metal ion concentration up to 800 ppm, and a sodium concentration up to 500 ppm. As is mentioned supra, sodium concentration in the zircon bait sand used in the FIG. 1 fused silica furnace typically contains about 3 ppm sodium. However, in order to produce HPFS® material, especially those qualified for 193-nm lithographic applications, it is desired that the intermediate bait sand has a relatively low monovalent metal ion concentration of below 100 ppm, preferably below 50 ppm, and a sodium concentration of below 80 ppm, preferably below 30 ppm.

The step (a3) can be carried out according to any method used in the art of making fused silica material. For example, the soot may be produced in a flame hydrolysis process such as the VAD, OVD processes, or direct deposit process using the furnace of FIG. 1. Alternatively, the soot particles may be provided by using a plasma-assisted process. The soot particles comprise the particles of silica and optional dopants, such as alumina, titania, and the like. Likewise, step (a4) is typically carried out in accordance with the conventional fused silica making processes. The fused silica body thus produced in step (a4) may be consolidated or porous. The temperature required for the production of porous bodies is usually lower than for the production of consolidated body if the same furnace is used. If porous body is produced in step (d), the porous body may be further doped before densification into a consolidated glass at an even higher temperature. Methods for doping porous fused silica bodies are disclosed, for example, in U.S. Pat. Nos. 5,151,117; 5,236,481 and 6,474,106, the disclosure of which are relied upon and incorporated herein by reference in their entirety.

A third aspect of the present invention is the barrier material per se. The barrier material can be prepared according to any of the means discussed supra in connection with the process for suppressing monovalent ion migration of the present invention. The barrier material should advantageously comprise Al₂O₃ between 3% and 90% by weight, preferably between 5% and 80%, more preferably between 10% and 80%, still more preferably between 20% and 60%, of the total amount of alumina and silica. The barrier material has a sodium diffusion coefficient at 1000° C. of less than 1×10⁻⁸ cm²/s. Preferably, the barrier material consists essentially of alumina and silica. Preferably, the barrier material has a sodium diffusion coefficient at 1000° C. of less than 1×10⁻¹⁰ cm²/s. Preferably, the barrier material has a monovalent metal ion concentration less than 50 ppm, preferably less than 30 ppm, more preferably less than 20 ppm, most preferably less than 10 ppm. Preferably, the barrier material has a sodium ion concentration less than 50 ppm, preferably less than 20 ppm, more preferably less than 5 ppm, most preferably less than 500 ppb. The barrier material of the present invention is effective in suppressing migration of monovalent metal ion, especially alkali metal ion, particularly sodium, between inorganic materials at an elevated temperature. Preferably, for the best effect in suppressing the migration of monovalent metal ions, it is preferred that the silica and alumina distribute substantially evenly in the material. Preferably the barrier material forms a continuous layer when subjected to the elevated temperature at which the material is used. For the production of HPFS® material, it is preferred that the barrier material forms a continuous layer at a temperature higher than 1500° C.

While not intending to be bound by any particular theory, the present inventors believe that the reason why an Al-doped silica containing barrier layer works at all is not because its sodium content is low, but because sodium diffusivity within it is many orders of magnitude slower than in HPFS® itself. Sodium moves effectively instantly through the crushed zircon bait sand typically used in the direct-deposit furnace illustrated in FIG. 1 because (1) it is a stable gas at silica laydown temperatures (anywhere above about 1200° C.) and (2) even that fraction in a liquid phase will percolate by grain boundary diffusion, which is many orders of magnitude faster than volume diffusion. If crushed HPFS® is used as a bait instead of, or in addition to, crushed zircon bait sand, it immediately gets covered with sodium released by the zircon brick/bait and then is a secondary sodium source for the boule above. This situation is better than crushed zircon refractory because even a rapid solid-phase diffusion rate is better than a very, very rapid grain boundary diffusion rate. However, it is not much better because volume diffusion is very fast, about 1.8×10⁻⁶ cm²/sec at 1600° C., as discussed supra and below.

When silica soot doped at a relatively low level of aluminum (about 3-4 wt % Al₂O₃, as in the waveguide Al-doped silica glass produced using the OVD process and the soot doped with AlCl₃ salt discussed in the examples below), the sodium profile in HPFS® is greatly diminished in magnitude, but not in length. Since sodium diff-uses at the same fast rate in the HPFS® boule regardless of the bait sand/barrier layer material, we do not expect the extent of its travel through the boule to be impacted by the choice of bait material. As noted above, however, the sodium content of the waveguide Al-doped silica glass and the Al-doped soot bait produced using AlCl₃ salt solution were definitely non-negligible compared to the amounts required for a 193-nm qualified fused silica, which is typically less than 50 ppb. Indeed, the sodium content in the HPFS® boules produced in the single burner refractory furnaces have a much lower sodium content than the various bait sand/barrier layer materials tested. It is because sodium is being supplied at a rate that is falling exponentially with time as it is depleted from the interface between the bait sand/barrier layer and the HPFS® boule. The crushed zircon bait can continue to supply sodium basically as fast as it can be incorporated, but once the near-surface sodium is removed from the barrier layer, the next aliquot of sodium must diffuse in zircon bait or volume diffusion in HPFS®, the absolute concentration of sodium in the boule decreases. Eventually the sodium-leached layer would become deep enough that the sodium source would basically dry up.

When a silica soot-γ-Al₂O₃ composite is used as a bait, a liquid forms containing as much aluminum in it as the bait sand/barrier layer temperature will allow. This binds together the alumina particles and promotes reaction to convert the remaining alumina into mullite. As all of this is going on, the sodium originally in the barrier layer gets dried up in either an aluminosilicate liquid containing a very high concentration of alumina, or in crystalline phases as the reaction between silica and alumina proceeds. We do not know with certainty that the composition of the equilibrium liquid is, but it is clearly much more Al₂O₃-rich than the Al-rich waveguie glass (“OWG Bait,” Example 2, infra, 2.7 wt % of Al₂O₃) and the AlCl₃ doped silica soot barrier layer material (Example 3, infra, 4 wt % of Al₂O₃). As a result, sodium diffusion is expected to be much slower in the silica soot/γ-Al₂O₃ barrier layer than in the HPFS® boule. This has the effect of making sodium source still more “finite,” not because the sodium concentration is any different, but because once a very thin near-surface layer is depleted of its sodium the source basically dries up. The thickness of this layer decreases exponentially with decreasing diffusivity. Therefore, in the limit of a long HPFS® campaign the sodium profile will asymptotically approach a very low, flat distribution as the sodium difflusivity of the bait decreases, assuming that sodium diffusion from the bottom substrate and bait sand is the primary sodium source for the HPFS® boule.

As the Al₂O₃ content of the barrier layer increases, even though some small amount of sodium introduced by, for example, flawed handling or contaminated batch materials, inevitably enters into the HPFS® boule, the magnitude of the reservoir of sodium falls effectively exponentially with sodium content. The small amount of sodium that even made it into the HPFS® then smoothly redistributed from top to bottom. For example, a barrier layer containing 3 ppm sodium with a diffusivity of 10⁻¹¹ cm²/sec at laydown temperatures will contribute so little sodium to the boule that, were it redistributed over the entire 10″ thickness of the boule, it would rise no higher than 1 ppb. An added benefit implied by this analysis is that at high Al₂O₃ levels, it may not matter how much contamination is introduced, as the small amount of sodium that makes it into the boule will be redistributed over much of its thickness, and may be below detection in the final analysis. This is the reason why sources containing relatively high sodium concentration, such as boehmetic alumina, calcined kaline clay, and the like, may be used as the alumina source, and why silica soot source material having relatively high sodium may be tolerated in the processes of the present invention as well.

The following non-limiting examples further illustrate the present invention.

### EXAMPLES

### Example 1 (Comparative Example)

This Example shows that sodium ion diffusion is much slower in an Al-rich glass than in fused silica. It is a comparative example because it does not involve the use of silica soot aqueous suspension to prepare the Al₂O₃—SiO₂ material of the barrier layer.

A 193 nm-quality HPFS® cylinder having sodium concentration less than 50 ppb was core-drilled to obtain a 2″ diameter boule. The boule was sliced into ¼″ thick disks. One face of the disks was ground to an optical polish. Each disk was leached in a mixture of 5% HCl, 5% nitric acid and 5% HF for 10 minutes in a clean Teflon® beaker inserted in an ultrasonic bath. The leached disks were sonicated 3 more times in triply deionized water, then dried in air on a clean plastic sheet. A calcium aluminosilicate glass (hereinafter “Al-rich glass”) having a composition, in mole percentage, of 63% SiO₂, 20.5% Al₂O₃ and 16.5% CaO, was melted. A patty of the glass was core drilled to produce disks identical in size of the corresponding HPFS® a disks, again with one face taken to an optical polish. These Al-rich glass disks were leached and dried as above for the HPFS® disks.

Five grams of sodium metasilicate hydrate was dissolved into an equal mass of triply deionized water. Then a single drop (˜100 μl) of the solution was dropped on the polished face of an HPFS® disk. A polished face of one of the Al-rich glass disk was then placed onto the droplet and forced against the HPFS® until most of the solution squirted out the sides. The two disks were carefully separated and placed in a small resistance furnace to dry at 120° C. After ten minutes, the opposing polished faces were once again brought together, and this “sandwich” was heated 10 minutes at 1000° C. to drive off any remaining water from the water glass. The sandwich was then placed on a pre-heated block of silica refractory and plunged into a furnace at 1600° C., aluminosilicate-side down.

After 20 minutes, the sandwich was removed from the furnace and was found to be bound firmly to the refractory block. The sandwich plus refractory block was immersed in a stream of cold flowing water and was held there until the hissing stopped (˜150° C.). This took about 5 minutes, but the sample was no longer incandescent in less than 1 minute. This rapid quench broke the seal between the aluminosilicate glass and refractory block. The two disks were considerably shattered by the rapid quench and large difference in their CTEs, but several 0.5-1 cm pieces with intact boundary layers were recovered. One of these was submitted for microprobe analysis.

FIG. 2 shows the microprobe analysis result moving from the surface of the Al-rich glass into the HPFS® sample. It is clear from this figure that aluminum is almost completely immobilized in the Al-rich glass and did not migrate into the HPFS® sample. It is also clear that sodium concentration in the Al-rich glass was much higher than that in the HPFS® sample. Sodium was essentially below detection limits in the HPFS® sample near the interface. Clearly at the boundary of the Al-rich glass and the HPFS® sample, there is a sharp drop of sodium concentration. This indicates that the sodium ions contained in the Al-rich glass has limited mobility which prevents them from migrating into the HPFS® sample, suggesting that the sodium ions are trapped in the Al-rich glass.

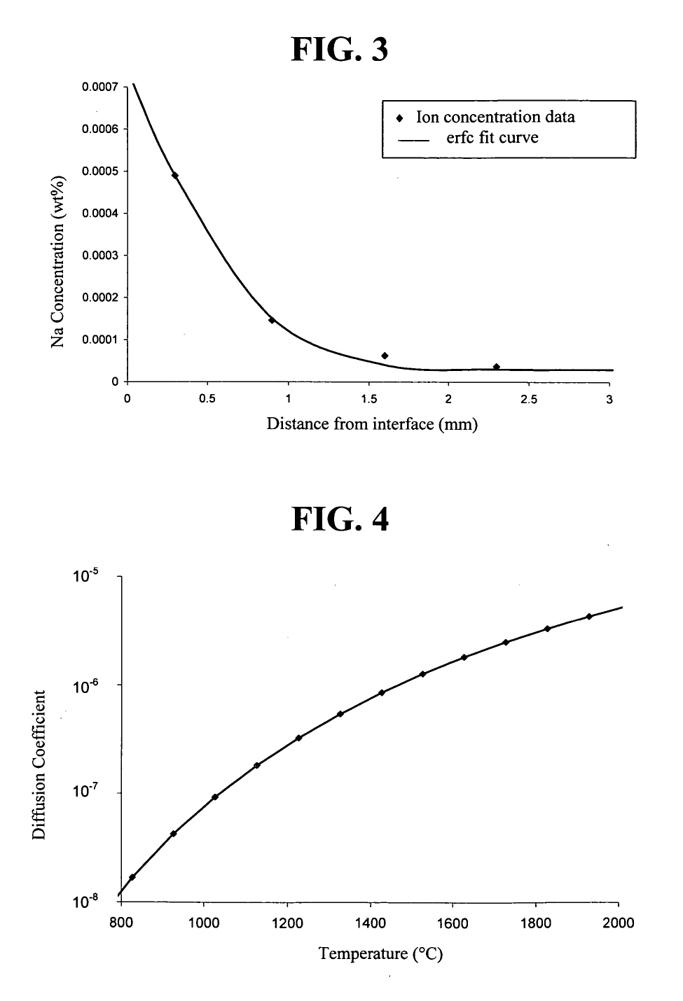

The sample was further examined using dynamic second ion mass spectroscopy. Though this method lacks the spatial resolution of microscope, its dynamic range is far greater, and it was expected that sodium in the HPFS® sample could be detected. Indeed, a sodium diffusion profile was detected that extended nearly 2 mm into the HPFS® sample and away from the interface. This profile and an erfc fit curve are shown in FIG. 3.

The implied diffusivity of sodium calculated from the erfc fit curve at 1600° C., 1.8×10⁻⁶ cm²/s, is extraordinarily fast. Using the equation for rms diffusion distance, this corresponds to 19 μm/s, or 1.1 mm/hour. Since the rms diffusion distance corresponds to the 1/e concentration relative to the peak, sodium originating from only one face of the HPFS® slab would actually extend several millimeters into HPFS® after an hour.

It is known that in commercial production of HPFS® in direct deposit furnaces as illustrated in FIG. 1, the growth rate of HPFS® boule is on the order of millimeters per hour. If the bait sand having direct contact with the fused silica boule has a high Na concentration, for example, 3 ppm (which is the case of some zircon bait), and the sodium is easily mobilized at the laydown temperature of the boule, a natural conclusion would be the sodium would then move from the bait sand and distribute throughout the boule, inasmuch as the sodium diffusion rate is comparable to the boule growth rate.

Zircon refractories, including the cup substrate and the bait sand, were usually chlorine treated to reduce sodium. We performed experiments to find that the residue sodium in the zircon refractories, usually about 3 ppm, was not susceptible for further chemical removal using acid leaching. However, once they were subjected to an elevated temperature, such as a temperature over 1000° C., sodium was mobilized.

It has also been found that a sodium gradient exists in HPFS® boules produced in FIG. 1 furnaces where zircon bait sand and zircon refractory cups having sodium in the ppm level were used. Sodium concentration in these boules from the bottom of the boule (closer to the bait sand) to the top of the boule (closer to the burners).

Based on these experiments, we came to the conclusion that most, if not all, sodium ions in HPFS® boules produced in furnaces of FIG. 1 using typical bait sand and refractory having sodium in the ppm level, originates from the sodium containing cup substrate and/or the bait sand.

An approximation of sodium diffusion at any temperature was conducted using the activation energy of 100 kJ/K.mol determined by Dieckmann et al. The result of the calculation is shown in FIG. 4. It is surprising to find that between 1400° C. and 2000° C., the diffusivity changed by only about a factor of five; in other words, the rms diffusion length of sodium only changes by about 2 times over this wide range of temperature. Therefore, the precise temperature at the bottom of a HPFS® boule produced in a FIG. 1 furnace is not particularly important as far as the final sodium profile is concerned. It is thus expected that the diffusion rate is comparable to the laydown rate, and because of the large amount of refractory and bait sand at the base of the boule, there is effectively an infinite supply of sodium to contaminate HPFS® if the refractory and bait sand contain sodium in the ppm level.

Therefore, from this Example, it is clear that a barrier layer between (1) the bait sand, or the refractory substrate of the cup, having sodium in the ppm level, and (2) the HPFS® boule, which functions to suppress the sodium migration from the refractories and bait sand to the HPFS® boule above, can reduce the sodium level in the fused silica boule produced. This Example also indicates that an Al-containing glass may be capable of suppressing sodium migration if used as a barrier layer, inasmuch as sodium ions in the Al-containing glass are immobilized.

### Example 2 (Comparative Example)

In this example, several bait materials were tested in a single burner refractory furnace for their influence on the sodium concentration of fused silica boule produced. It is a comparative example because none of the bait materials tested was prepared by using silica soot aqueous suspension.

The single-burner furnace comprises a metal frame holding a 3″ thick refractory ringwall and a rotating center base or turntable. The turntable comprises a refractory sub-base, base and cup. The crown, ringwall, cup, and cup liners are made from zircon refractory. The crown and cup liners have been cleaned through a purification process called calcining which involves heating the refractory to an elevated temperature in a chlorine/helium atmosphere. The turntable rotates and can also be raised and lowered; this controls the size of the gap between the crown and top of the cup, which, in turn, controls the temperature of the glass during forming.

All parameters were duplicated run-to-run as close as possible. The crown refractory can be used for multiple runs. New cup liners are used for each run as they become fused to the boule during each run and break up on cooling and can not be reused. Three types of bait materials were used: crushed zircon brick, Mintec cullet, and Al-doped optical waveguide glass. Concentrations (ppm) of metals contained in these bait materials obtained by chemical analysis are shown in TABLE 1. The bait materials were:

Crushed zircon brick (“Zircon Bait” in TABLE 1): This bait material was made from used production furnace crown bricks, which were crushed, run through a magnetic separator (to remove iron particles) and sized. This bait was used in all four runs, approximately 1000 grams was used and placed in the bottom of the cup alone or as the first layer.

Mintec glass cullet (“Mintec Bait” in TABLE 1): This was produced from the webbing material left from HPFS® production boules after all usable parts were extracted. The webbing was crushed, run through an iron separator, sized, and acid-washed.

Al-doped optical waveguide glass (“OWG Bait” in TABLE 1): This glass was produced by using the OVD process. This glass was received as a consolidated waveguide blank with about 1″ diameter, weighing about 1000 grams. The blank was placed in a heavy plastic bag and broken into chunks, the largest about ¼″ across.

TABLE 1
Part I

| | Al | Na | Fe | Ti | Cr | Cu | Li | Mg |
|---|---|---|---|---|---|---|---|---|
| Zircon | 1700 | 1.58 | <1 | 367 | 2.85 | <1 | <1 | 1.89 |
| Bait | | | | | | | | |
| Mintec | 15 | 1.63 | 0.32 | 1.10 | 0.04 | 0.01 | 0.48 | 0.47 |
| Bait | | | | | | | | |
| OWG Bait | 14500 | 0.38 | 0.04 | 0.36 | 0.00 | 0.00 | 0.00 | 0.32 |

Part II

| | Ni | U | V | Zn | Zr | Ca | Ce | K |
|---|---|---|---|---|---|---|---|---|
| Zir- | <1 | 207 | 1.72 | <2 | n/a | 3.72 | <5 | 2.07 |
| con | | | | | | | | |
| Bait | | | | | | | | |
| Min- | 0.03 | 0.09 | 0.00 | 0.01 | 1.84 | 1.00 | 0.07 | 0.91 |
| tec | | | | | | | | |
| Bait | | | | | | | | |
| OWG | 0.00 | <0.0001 | <0.0001 | 0.00 | 0.00 | 0.08 | <0.0005 | 0.02 |
| Bait | | | | | | | | |

The actual furnace runs comprised a pre-heat where the burner was ignited with the turntable in the lowest position. Over a period of 1.5 hours, the gas flows were increased to the required flows and the crown-cup gap was reduced until the required crown temperature of 1660° C. to 1670° C. was achieved. At this point the silicon precursor flow was started and glass formation began.

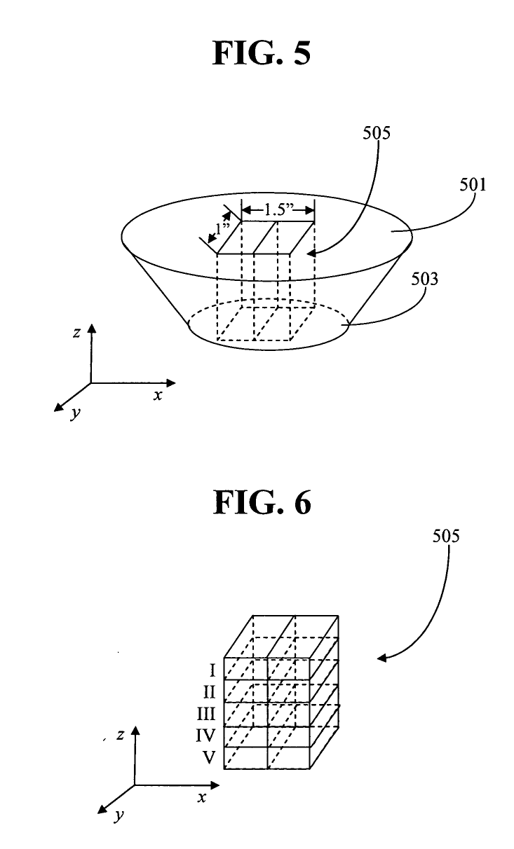

Glass formation continued for about 7 hours, which formed a boule averaging 1.5″ thick. The silicon precursor flow was first shut down and then all gas flows were shut down and the furnace was allowed to cool. The boule was then removed from the cup and cut into samples for analysis. The boule is schematically shown in FIG. 5, where 501 is the top surface and 503 is the bottom, which may include part of the bait sand or barrier layer.

As shown in FIGS. 5 and 6, a 1.5″×1″ section 505 was cut from the center of each boule and then sliced into 5 mm thick subsections. These subsections were labeled as sections I, II, III, IV, V, . . . , successively. Each subsection was cut in half (along the 1.5″ dimension) to provide two 1″×¾″ samples for duplicates. The samples were typically cleaned in HF, HNO₃ and HCl for multiple times before analysis.

Four experiment runs A, B, C and D were conducted. In these experiments, the combination of bait materials for each experiment is described below, and TABLE 2 shows the gas flows used for these runs and the boule thickness that resulted.

Experiment A: 1000 grams of crushed zircon bait were placed in the cup bottom and leveled. Fused silica glass was directly deposited on the zircon. A new crown was used for this experiment, which served as a conditioning run. The same crown was used for Experiments B, C and D.

Experiment B: 1016 grams of crushed zircon were placed in the cup bottom and leveled, followed by 586 grams of crushed OWG bait that was evenly placed directly over the crushed zircon.

Experiment C: 1004 grams of crushed zircon were placed in the cup bottom (identical conditions to Experiment A).

Experiment D: 976 grams of crushed zircon were placed in the cup bottom and leveled, topped by 1000 grams of Mintec bait, evenly placed over the crushed zircon.

TABLE 2

| | Inner | Outer | | | | | | |
|---|---|---|---|---|---|---|---|---|
| | Shield | Shield | Premix | Premix | Fume | | Run | Glass |
| | O₂ | O₂ | O₂ | CH₄ | N₂ | OMCTS | Time | thickness |
| Experiment | (slpm) | (slpm) | (slpm) | (slpm) | (slpm) | (gm/min) | (hours) | (inches) |
| A | 8 | 16 | 21.5 | 20 | 5.4 | 6.6 | 7.25 | 1.25 |
| B | 8 | 16 | 21.5 | 20 | 5.4 | 6.6 | 7 | 1.75 |
| C | 8 | 16 | 21.5 | 20 | 5.4 | 6.7 | 7.5 | 1.63 |
| D | 8 | 16 | 21.5 | 20 | 5.4 | 6.6 | 7 | 1.75 |

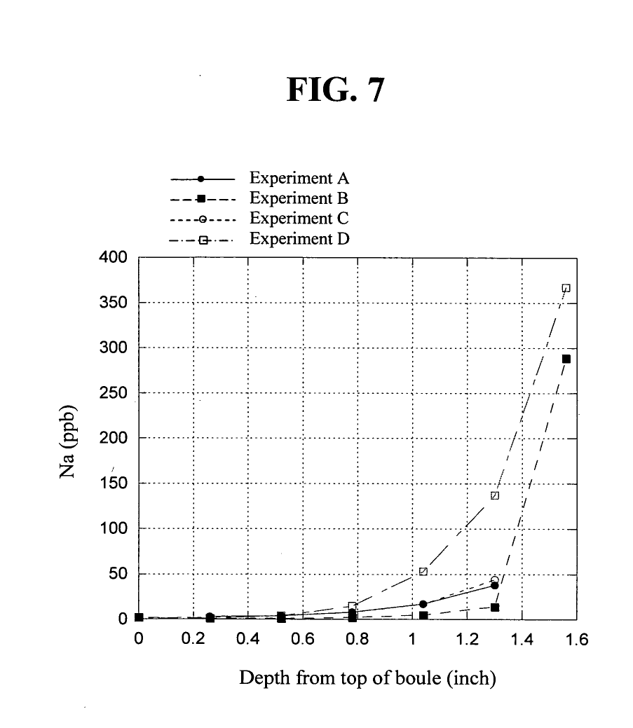

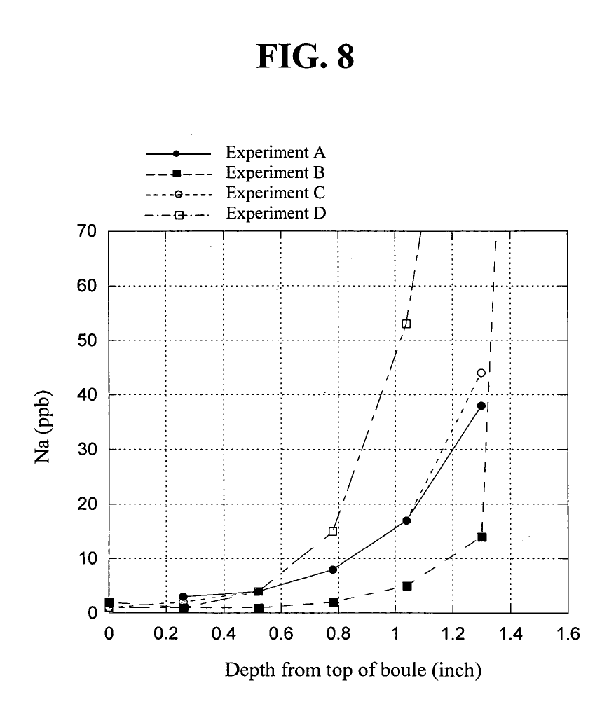

The glass samples were analyzed by traditional wet chemistry and inductively coupled plasma/mass-spectrometry (ICP/MS) techniques. The detected sodium concentration in the boules as a function of depth form the top is shown in FIGS. 7 and 8. FIG. 8 is a partial enlargement of FIG. 7.

The two repeating experiments, Experiments A and C, were glass deposited directly on crushed zircon ceramic. The chemistry of the two samples matched very well indicating that the technique is repeatable. The glasses were deposited on glasses in Experiments B and D. These graphs clearly show that the sodium concentrations in the HPFS® boules produced are dependent on the bait materials used.

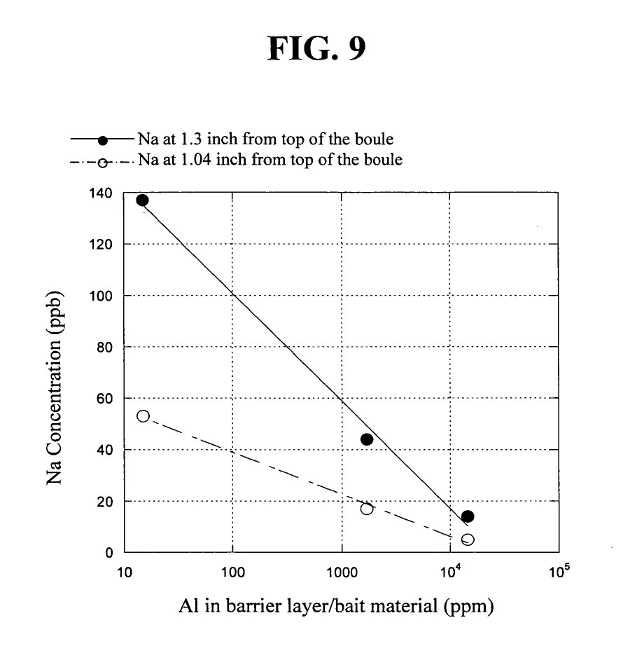

The plot in FIG. 9 illustrates that the Na in the deposited glass correlated well with the Al in the materials that the glass is directly deposited on. These data clearly suggest that the Al in the materials does act as a barrier to Na diffusion. The higher the Al concentration in the barrier bait material, the lower the sodium concentration in the fused silica boule at a given depth from the top.

### Example 3 (the Present Invention)

In this example, a dense Al₂O₃—SiO₂ brick with approximately 2.7 wt % Al₂O₃ was prepared using silica soot and AlCl₃.

A basic aqueous solution was prepared by combining 180 grams of 28% ammonium hydroxide solution with 660 grams of 18 MΩ deionized water. High purity reagents are required to avoid sodium contamination. The solution was transferred to an acid-leached 4 liter fluorocarbon beaker, and a fluorocarbon-coated stirrer was inserted. The solution was stirred for approximately 30 minutes at 200 rpm. Approximately 900 grams of HPFS bag house soot was added at approximately 40 grams per load, waiting in between each addition to ensure that the last load was completely dispersed into the suspension. When the last of the soot was added, the solution was stirred for approximately 2 hours to promote uniformity and to dissolve silica into solution. An aqueous solution was prepared using 120 grams of 99.9995% aluminum chloride hexahydrate (AlCl₃.6H₂O) dissolved completely in 160 grams of 18 MΩ deionized water. This produced a somewhat acidic aqueous solution. The aluminum chloride solution was added in 10 ml aliquots to the basic soot slurry, waiting in between each addition to let the gel formed during its addition to completely dissipate into the slurry. When the addition was complete, the viscosity of the slurry was relatively high. At this point it could potentially be delivered directly into the cup of an HPFS furnace, heated at low temperature to dry, and fired with the deposition burners to ˜2000° C. to fuse it into glass.

In the present example, the slurry was poured directly into a flat polypropylene pan and heated for 16 hours at 120° C. to obtain a cracked Al-doped soot “cake.” The cake was removed and transferred to a fused silica container and returned to the furnace. The furnace temperature was increased to approximately 250° C. to drive off ammonia and then to approximately 350° C. to drive off ammonium chloride. The furnace was then ramped to 750° C. and held for approximately 1 hour to decompose any remaining aluminum chloride. Finally, the furnace temperature was increased to 1000° C. to completely decompose any remaining hydrous silica or hydrous alumina in the interstices between the soot particles. After two hours, the cake was removed from the furnace and allowed to cool to room temperature.

At this point, the cake could be crushed and sieved into particles suitable for use directly as a bait material. Alternatively, the intact cake or crushed particles can be heated to approximately 1750° C. and converted into fused glass. At 1600° C., substantial fusion takes place as well due to the eutectic between silica and mullite. This temperature can be used to obtain a dense, fused ceramic that will be completely melted into Al-doped silica glass during the initial heat-up stage in HPFS® production.

### Example 4 (the Present Invention)

The following illustrates the means by which we prepared a dense Al₂O₃—SiO₂ brick with approximately 50 wt % Al₂O₃ of the total of Al₂O₃ and SiO₂.

One liter of reagent-grade 28% NH₄OH was poured into a 4 liter PTFE beaker and stirred. Approximately 500 grams of 99.997% γ-Al₂O₃ was added to the solution and stirred for about 3 hours. After this time, approximately 500 grams of HPFS® bag house soot was slowly added to the solution over about 15 minutes. The resulting suspension was stirred vigorously for approximately 30 minutes longer, at which point its viscosity was just low enough to pour out of the beaker. As with the soot gel made with acidic salts (Example 3), the slurry was poured into polypropylene molds and allowed to air-dry for about 24 hours. Drying proceeded at a rate of about 3 cm per 24 hours at room temperature, but proceeded much faster at elevated temperature, e.g., 2-3 hours for 3 cm thick material at 95° C. After most water and ammonia was driven off, the material was transferred to fused quartz crucibles and fired to about 400° C. to drive off remaining water. This relatively low temperature preserved the high level of chemical activity of the γ-Al₂O₃ dopant while providing greater mechanical integrity for the material.

The resulting material was fairly dense (˜70-80% theoretical) and brick-like, and is easily milled into appropriate size for use as bait material.

This basic method was scaled up to approximately 30 kg batches with no difficulty other than the difficulty of handling large volumes of ammonium hydroxide.

### Example 5 (the Present Invention)

In this Example, the Al₂O₃—SiO₂ materials produced in Examples 3 and 4 were tested of their ability to suppress sodium migration to fused silica in a single burner refractory furnace. Another Al-doped optical waveguide glass produced by using the OVD process was also tested in this example. The testing procedures are substantially the same as those described in Example 2, supra.

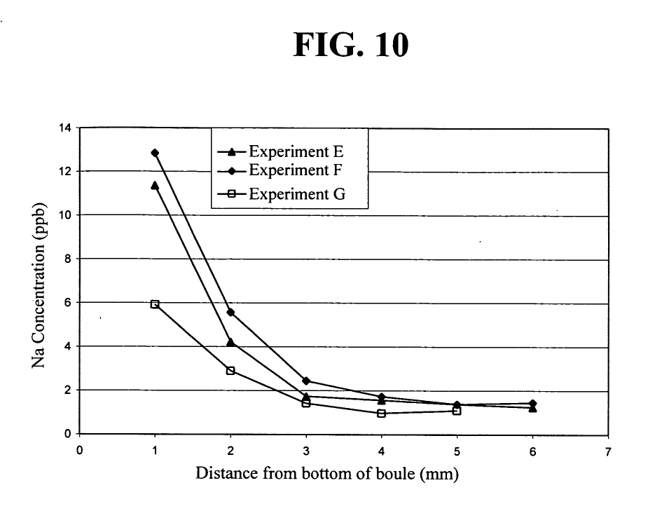

FIG. 10 shows the Na concentration in ppb in the boules produced using these materials as barrier layers. as a function of the distance from the bottom of the boule. The three experiment runs were:

Experiment E: Al-doped waveguide glass was used as the barrier layer material. The glass used was the same as the one used in Experiment B of Example 2;

Experiment F: Al-doped silica soot produced in Example 3, supra, was used as the barrier layer material;

Experiment G: Al₂O₃—SiO₂ material prepared form γ-Al₂O₃ and silica soot as in Experiment 4, supra, was used as the barrier layer material.

FIG. 10 clearly shows that the boule produced produced in Experiment runs G had the lowest sodium concentration in the bottom area abutting the barrier layer. It is clear from this graph that, at a given depth from the bottom of the boule, sodium concentration in the boule is lower where the bait material/barrier layer has a higher amount of aluminum.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

1. A process for suppressing the migration of monovalent metal ion from a first inorganic material to a second inorganic material at an elevated temperature, comprising forming a Al₂O₃—SiO₂-containing barrier layer sandwiched between the surfaces of the first inorganic material and the second inorganic material, wherein the material of the barrier layer is prepared from an aqueous slurry comprising silica soot particles.

2. A process in accordance with claim 1, wherein the monovalent metal ion is selected from alkali metal ions, Cu⁺, Ag⁺, and mixtures thereof.

3. A process in accordance with claim 1, wherein the monovalent metal ions is sodium ion.

4. A process in accordance with claim 1, wherein the silica soot has an average particle diameter less than 1 μm.

5. A process in accordance with claim 1, wherein the silica soot is produced in a flame hydrolysis process and has a sodium concentration of less than 1 ppm.

6. A process in accordance with claim 1, wherein the material of the barrier layer comprises Al₂O₃ from 3-90% by weight of the total of Al₂O₃ and SiO₂.

7. A process in accordance with claim 6, wherein the material of the barrier layer comprises Al₂O₃ from 5-80% by weight of the total of Al₂O₃ and SiO₂.

8. A process in accordance with claim 6, wherein the material of the barrier layer comprises Al₂O₃ from 20-60% by weight of the total of Al₂O₃ and SiO₂.

9. A process in accordance with claim 1, wherein the barrier layer is formed in accordance with a process comprising the following steps:
(i) providing an alkaline aqueous suspension of silica soot;
(ii) providing a hydrolysable aluminum compound having the general formula
Sₒ—Al—Yₚ (I)
or hydrates thereof,
where S independently is a non-hydrolysable group, Y independently is a hydrolysable group, o is an integer from 0 to 2, inclusive, p is an integer from 1 to 3, inclusive, and o+p=3; and
(iii) adding, while stirring, the hydrolysable compound provided in step (ii), and/or a solution/suspension thereof, to the aqueous suspension of silica soot provided in step (i), to form an aqueous slurry.

10. A process in accordance with claim 9, wherein in formula (I), S independently is selected from optionally fluorinated C₁-C₂₄ alkyl and optionally fluorinated phenyl, and Y independently is selected from the group consisting of halogen, NO₃, NO₂, CH₃COO, hydrogen and OR′ where R′ is a C₁-C₄ alkyl.

11. A process in accordance with claim 9, wherein the hydrolysable aluminum compound is selected from the group consisting of aluminum halides, Al(NO₃)₃, Al(NO₂)₃, Al(CH₃COO)₃, hydrates thereof, and mixtures thereof.

12. A process in accordance with claim 1, wherein the barrier layer is formed in accordance with a process comprising the following steps:
(A) providing an alkaline aqueous suspension of silica soot;
(B) providing a suspension of alkaline aqueous suspension of alumina particles;
(C) mixing the suspension of silica soot provided in step (A) with the suspension of alumina particles provided in step (B) to form an aqueous slurry.

13. A process in accordance with claim 12, wherein in step (B), the alumina particles are α-alumina and/or γ-alumina particles.

14. A process in accordance with claim 1, wherein the barrier layer is formed in accordance with a process comprising the following steps:
(a) providing an alkaline aqueous suspension of silica soot; and
(b) adding, while stirring, alumina particles to the aqueous suspension of silica soot to form an aqueous slurry.

15. A process in accordance with claim 14, wherein in step (b), the alumina particles are α-Al₂O₃ and/or γ-Al₂O₃ particles.

16. A process in accordance with claim 1, wherein the barrier layer is formed in accordance with a process comprising the following steps:
(1) providing an alkaline aqueous suspension of alumina particles; and
(2) adding, while stirring, silica soot into the aqueous suspension provided in step (1) to form an aqueous slurry.

17. A process in accordance with claim 16, wherein in step (1), the alumina is α-Al₂O₃ and/or γ-Al₂O₃.

18. A process in accordance with claim 1, wherein the barrier layer is formed in accordance with a process comprising the following steps:
(x) providing an alkaline aqueous solution;
(y) adding, while stirring, silica soot and alumina particles into the aqueous suspension provided in step (x) to form an aqueous slurry.

19. A process in accordance with claim 18, wherein in step (x), the alumina is α-Al₂O₃ and/or γ-Al₂O₃.

20. A process in accordance with claim 1, wherein the barrier layer is formed by the following steps:
(A1) providing an aqueous slurry comprising silica soot and alumina particles;
(A2) drying the slurry provided in step (A1) to obtain a solid mixture of Al₂O₃ and SiO₂;
(A3) reducing the solid mixture obtained in step (A2) into particles; and
(A4) depositing a layer of particles obtained in step (A3) between the first and second inorganic materials as the barrier layer.

21. A process in accordance with claim 1, wherein the barrier layer is formed by the following steps:
(A1) providing an aqueous slurry comprising silica soot and alumina particles;
(A2′) depositing a layer of the slurry provided in step (A1) over the contacting surface of at least the first inorganic material;
(A3′) drying the slurry and heating the slurry to an elevated temperature to form the barrier layer between the first and second inorganic materials in situ.

22. A process for forming silica-containing body, comprising the following steps:
(a1) providing a substrate having a top surface;
(a2) providing a barrier layer comprising alumina and silica that suppresses monovalent metal ion migration at elevated temperature over the top surface of the substrate, wherein the barrier layer is prepared from an aqueous suspension comprising silica soot;
(a3) providing soot particles at an elevated temperature; and
(a4) collecting the soot particles on top of the barrier layer to form the silica-containing body at an elevated forming temperature in a furnace.

23. A process in accordance with claim 22, wherein in step (a1), the substrate provided has a sodium concentration of at least 500 ppb.

24. A process in accordance with claim 22, wherein in step (a3), the temperature is over 1500° C.

25. A process in accordance with claim 22 further comprising, after step (a1) and prior to step (a2), an additional step (b1):
(b1) providing a bait sand layer on the top surface of the substrate;
whereby in step (a2), the barrier layer is formed on top of the bait sand layer.

26. A process in accordance with claim 25, wherein in step (b1), the bait sand layer provided on the top surface of the substrate has a sodium concentration of at least 500 ppb.

27. A process in accordance with claim 22, wherein the silica soot comprised in the aqueous suspension provided in step (a2) has an average particle diameter less than 1μm.

28. A process in accordance with claim 22, wherein the silica soot is produced in a flame hydrolysis process and has a sodium concentration of less than 1 ppm.

29. A process in accordance with claim 22, wherein the material of the barrier layer comprises Al₂O₃ from 3-90% by weight of the total of Al₂O₃ and SiO₂.

30. A process in accordance with claim 29, wherein the material of the barrier layer comprises Al₂O₃ from 5-80% by weight of the total of Al₂O₃ and SiO₂.

31. A process in accordance with claim 29, wherein the material of the barrier layer comprises Al₂O₃ from 20-60% by weight of the total of Al₂O₃ and SiO₂.

32. A process in accordance with claim 22, wherein the barrier layer is formed in accordance with a process comprising the following steps:
(i) providing an alkaline aqueous suspension of silica soot;
(ii) providing an aqueous solution/suspension of a hydrolysable aluminum compound having the general formula
Sₒ—Al—Yₚ (I)
and hydrates thereof,
where S independently is a non-hydrolysable group, Y independently is a hydrolysable group, o is an integer from 0 to 2, inclusive, p is an integer from 1 to 3, inclusive, and o+p=3; and
(iii) mixing the silica soot suspension provided in step (i) with the aqueous solution/suspension provided in step (ii) to form an aqueous slurry.

33. A process in accordance with claim 32, wherein in formula (I), S independently is selected from optionally fluorinated C₁-C₂₄ alkyl and optionally fluorinated phenyl, and Y independently is selected from the group consisting of chlorine, hydrogen and OR′ where R′ is a C₁-C₄ alkyl.

34. A process in accordance with claim 32, wherein the hydrolysable aluminum compound is selected from the group consisting of aluminum halides, Al(NO₃)₃, Al(NO₂)₃, Al(CH₃COO)₃, hydrates thereof, and mixtures thereof.

35. A process in accordance with claim 22, wherein the barrier layer is formed in accordance with a process comprising the following steps:
(A) providing an alkaline aqueous suspension of silica soot;
(B) providing a suspension of alkaline aqueous suspension of alumina particles;
(C) mixing the suspension of silica soot provided in step (A) with the suspension of alumina particles provided in step (B) while stirring to form an aqueous slurry.

36. A process in accordance with claim 35 wherein in step (B), the alumina is α-alumina or γ-alumina.

37. A process in accordance with claim 22, wherein the barrier layer is formed in accordance with a process comprising the following steps:
(a) providing an alkaline aqueous suspension of silica soot; and
(b) adding, while stirring, alumina particles to the aqueous suspension of silica soot to form an aqueous slurry.

38. A process in accordance with claim 37, wherein in step (b), the alumina particles are α-Al₂O₃ and/or γ-Al₂O₃ particles.

39. A process in accordance with claim 22, wherein the barrier layer is formed in accordance with a process comprising the following steps:
(1) providing an alkaline aqueous suspension of alumina particles; and
(2) adding, while stirring, silica soot into the aqueous suspension provided in step (1) to form an aqueous slurry.

40. A process in accordance with claim 40, wherein in step (1), the alumina is α-Al₂O₃ and/or γ-Al₂O₃.

41. A process in accordance with claim 22, wherein the barrier layer is formed by the following steps:
(A1) providing an aqueous slurry comprising silica soot and alumina particles;
(A2) drying the slurry provided in step (A1) to obtain a solid mixture of Al₂O₃ and SiO₂;
(A3) reducing the solid mixture obtained in step (A2) into particles; and
(A4) depositing a layer of particles obtained in step (A3) over the top surface of the substrate as the barrier layer.

42. A process in accordance with claim 22, wherein the barrier layer is formed by the following steps:
(A1) providing an aqueous slurry comprising silica soot and alumina particles;
(A2′) depositing a layer of the slurry provided in step (A1) over the top surface of the substrate; and
(A3′) drying the slurry and heating the slurry to an elevated temperature to form the barrier layer over the top surface of the substrate in situ.

43. A process in accordance with claim 22, wherein the silicon-containing body formed has a Na concentration less than 20 ppb in the area abutting the barrier layer.

44. A process in accordance with claim 22, wherein the silicon-containing body formed has a Na concentration less than 10 ppb in the area abutting the barrier layer.

45. A process in accordance with claim 22, wherein in step (b), the barrier layer, when dried and subjected to a temperature over 1200° C., has a thickness less than 2 cm.

46. A process in accordance with claim 22, wherein the silicon-containing body is formed in a direct-deposit flame hydrolysis furnace, and the substrate provided in step (a1) is the bottom of the rotating cup for collecting the soot and forming the body therein.

47. An barrier material comprising silica and alumina for suppressing the migration of monovalent metal ion between inorganic materials at an elevated temperature, wherein the amount of alumina in the barrier material is between 3% and 90% by weight of the total amount of alumina and silica, and the barrier material has a sodium difflusion coefficient at 1000° C. of less than 1×10⁻⁸ cm²/s.

48. A barrier material in accordance with claim 47, wherein the amount of alumina is between 20% and 60% by weight of the total amount of alumina and silica.

49. A barrier material in accordance with claim 47 consisting essentially of alumina and silica.

50. A barrier material in accordance with claim 47 having a sodium diffusion coefficient at 1000° C. of less than 1×10⁻¹⁰ cm²/s.

51. A barrier material in accordance with claim 47 having monovalent metal ion concentration of less than 50 ppm.

52. A barrier material in accordance with claim 47 having a sodium metal ion concentration of less than 50 ppm.

53. A barrier material in accordance with claim 47 having a sodium metal ion concentration of less than 20 ppm.

54. A barrier material in accordance with claim 47 having a sodium metal ion concentration of less than 5 ppm.

55. A barrier material in accordance with claim 47 having a sodium metal ion concentration of less than 500 ppb.

56. A barrier material in accordance with claim 47, wherein the silica and alumina distribute substantially evenly in the material.

57. A barrier material in accordance with claim 47, which forms a continuous layer when subjected to the elevated temperature at which the material is used.

58. A barrier material in accordance with claim 47 which forms a continuous layer at a temperature about 1500° C.
